(19) United States
(12) Patent Application Publication
(10) Pub. No.: US 2007/0089948 A1
(43) Pub. Date: Apr. 26, 2007

(54) Viscous fluid sealing damper

(76) Inventors: Shinsaku Tanaka, Tokyo (JP); Takashi Yamanaka, Tokyo (JP); Rei Shukuya, Kawasaki-shi (JP)

Correspondence Address: BACON & THOMAS, PLLC, 625 SLATERS LANE, FOURTH FLOOR, ALEXANDRIA, VA, 22314, US

(21) Appl. No.: 11/583,081

(22) Filed: Oct. 19, 2006

(30) Foreign Application Priority Data
Oct. 19, 2005 (JP) 2005-303895

(51) Int. Cl. F16F 9/12; F16M 13/00

(52) U.S. Cl. 188/266; 267/140.11; 248/636

(57) ABSTRACT

The objective of the present invention is to provide a viscous fluid sealing damper having a compact and simple structure in which a sealed vessel is made of a single material having a high stirring efficiency and attenuation rate. The present invention proposes a viscous fluid sealing damper interposed between a first member and a second member for attenuating vibrations propagated between the first and second members, wherein a stirrer protrudes within a sealed vessel filled with viscous fluid and made of a single material from one end toward the other end thereof; a thin-wall is provided between the one end and the barrel of the sealed vessel; a first fitting is provided at the one end outside the outer periphery of the stirrer; and a second fitting is provided on the outer periphery of the barrel of the sealed vessel at a position where it surround the tip of the stirrer and its vicinity; and the first fitting is fitted on the first member and the second fitting is fitted on the second member.

### BACKGROUND OF THE INVENTION

1. Field of the Invention

The present invention relates to a viscous fluid sealing damper having a sealed vessel filled with viscous fluid and, for example, attached to a disc player mounted in a vehicle for attenuating external vibrations.

2. Description of the Prior Art

For example, for a disc player, a damper is interposed between the chassis (first member) and the frame (second member) so that the damper absorbs frame vibrations, thereby preventing external vibrations from being propagated to the optical pick-up. Such a damper is important for preventing external vibrations particularly in in-vehicle disc players.

For example, known vibration control means for in-vehicle disc players include a viscous fluid sealing damper having the structure shown in FIG. 4. Here, a viscous fluid sealing damper 103 is interposed between a chassis 101 (the first member) and a frame 102 (the second member) so that vibrations (external vibrations) propagated to the frame 102 from external sources are absorbed by the viscous fluid sealing damper 103 and, therefore, not further propagated to an un-shown optical pick-up on the chassis 101.

A spring 104 links the chassis 101 to the frame 2 to hold the chassis 101 in a fixed position. The viscous fluid sealing damper 103 comprises a sealed vessel 106 filled with oil 105 and consisting of a flexible end 107, which is made of soft resin, and a barrel 108 and a bottom 109, which are made of hard resin. The bottom 109 is secured to the frame 102.

Inside the sealed vessel 106 is provided a closed-end cylindrical stirrer 110 protruding from the top center of the end 107 toward the bottom 109 for stirring the viscous fluid within the vessel 106. A metal pin 111 is inserted in the stirrer 110 and the pin 111 is attached to the chassis 101.

When the frame 102 receives vibrations, the sealed vessel 106 is vibrated relative to the stirrer 110 in which the pin 111 is inserted. Then, flow resistance produced between the stirrer 110 and the oil 105 serves to attenuate the vibrations propagated to the chassis 101.

The Japanese Laid-Open Patent Publication No. 2003-139183 discloses a viscous fluid sealing damper wherein a damper (viscous fluid sealing damper 16) is interposed between a chassis (body mechanism unit 10) and a frame (supporting frame 22) so that external vibrations propagated through the frame are absorbed by the viscous fluid sealing damper and, therefore, not further propagated to an optical pickup on the chassis. In addition, a spring 14 links the chassis to the frame to hold the chassis in a fixed position.

The sealed vessel of this known viscous fluid sealing damper is made of soft resin from one end (the flexible part 30) to the interior of the barrel (the sidewall 24) while the exterior of the barrel and the bottom 26 are made of hard resin. The stirrer (stirrer 28) is made of soft resin in the form of a closed-end cylinder, into which a hard resin pin is inserted. The flange of the pin is interposed between the soft resin end and the chassis, integrally molding the soft and hard resin parts by co-injection molding.

Japanese Laid-Open Patent Publication No. 8-21474 discloses an air damper wherein:

a hollow rubber body 1 in the form of bellows is closed by closures 2 and 3 at either end to create an air chamber 4. A ventilation orifice 5 communicating with the air chamber 4 is formed in the bottom closure 3. A stirrer (the blade-like protrusion 6) for stirring air within the air chamber 4 is integrally molded with the top closure 2.

However, in the viscous fluid sealing damper shown in FIG. 4, the one end of the sealed vessel must be sufficiently spaced from the chassis so as not to make contact with the metal pin washer or the chassis, requiring sufficient distance between the chassis and the frame, hampering the down-sizing of the damper.

The sealed vessel is made of a combination of soft and hard resin and a metal pin, inserted in the stirrer, making the structure complex, as the sealed vessel must have a flexible end coupled to the chassis and a rigid barrel moving together with the frame to more efficiently stirring oil, the metal pin being used to provide rigid reinforcement of the stirrer.

In the viscous fluid sealing damper of the Japanese Laid-Open Patent Publication No. 2003-139183, the flange of the hard resin pin is interposed between the soft resin end and the chassis, enabling the chassis and the frame to be close to each other. However, the sealed vessel requires co-injection molding using soft and hard resins, also having a complex structure.

The sealed vessel of Japanese Laid-Open Patent Publication No. 8-21474 is made of only rubber, having a simple structure. An attempt to use this vessel for the viscous fluid sealing damper reveals a flexible hollow rubber body in the form of bellows and fails to improve stirring efficiency, making it unsuitable as a viscous fluid sealing damper.

The present invention is proposed in view of the above problems, the purpose of which is to provide a viscous fluid sealing damper having a compact and simple structure and a high stirring efficiency and attenuation rate.

### SUMMARY OF THE INVENTION

In order to achieve the above objective, the present invention proposes a viscous fluid sealing damper interposed between a first member and a second member for attenuating vibrations propagated between them, comprising a sealed vessel filled with viscous fluid, made of a single material, and having one end, other end, and a barrel, a stirrer protruding inside the sealed vessel from the one end toward the other end, a thin-wall provided to the sealed vessel between one end and the barrel, a first fitting provided at one end of the sealed vessel outside the outer periphery of the stirrer, and a second fitting provided on the outer periphery of the barrel of the sealed vessel in a position where it surrounds the tip and vicinity of the stirrer, wherein the first fitting is fitted on the first member and the second fitting is fitted on the second member.

The sealed vessel of the present invention consists of a vessel body ranging from the barrel to one end and a closure constituting the other end.

In an embodiment of the present invention, a viscous fluid sealing damper is proposed wherein the vessel body and the closure are integrated by bonding.

Furthermore, in the present invention, a viscous fluid sealing damper is proposed wherein the vessel body and the closure are made of rubber.

Furthermore, in the present invention, a viscous fluid sealing damper is proposed wherein the barrel of the vessel body has increased thickness inward at the tip.

Furthermore, in the present invention, a viscous fluid sealing damper is proposed wherein the first and second fittings are annular grooves.

In the present invention proposed above, the first fitting is provided at one end of the sealed vessel and is fitted on the first member. Therefore, the first and second members can be close to each other, allowing down-sizing. The first fitting is provided at the one end of the sealed vessel outside the outer periphery of the stirrer; therefore, the stirrer can bear the flow resistance of the viscous fluid even if it is not particularly rigid.

The second fitting is provided on the outer periphery of the barrel of the sealed vessel in a position surrounding the tip and vicinity of the stirrer and fitted on the second member. Therefore, the part of the barrel that should be reinforced most is reinforced by the second member. Consequently, the sealed vessel can be made of a single material without using a particularly hard material for the barrel, simplifying the structure.

The sealed vessel consists of a vessel body and a closure integrated by bonding, facilitating the production of the sealed vessel and the filling of viscous fluid. Careful material selection is required when a single resin material is used both in the flexible part and in the rigid parts. However, using rubber in the vessel body and the closure makes material selection easier than when using a synthetic resin.

Furthermore, a rubber vessel body provides a high static spring constant, allowing the elimination of a spring linking the chassis to the frame in the prior art.

With the barrel of the rubber vessel body having the thickness increased inward at the tip, the vessel body and the rubber closure can achieve larger area contact with each other, becoming securely bonded without increasing their external size. Furthermore, increased thickness at the barrel tip provides reinforcement for horizontal vibrations.

The first and second fittings in the form of an annular groove facilitate the fitting on the first and second members and assure secure fitting.

### BRIEF DESCRIPTION OF THE DRAWINGS

The present invention will become more apparent upon reading the following detailed specification with reference to the accompanying drawings, in which:

FIG. 1 is a vertical cross-sectional view showing the viscous fluid sealing damper according to Embodiment 1 of the present invention while it is in use.

FIG. 2 is a vertical cross-sectional view showing the viscous fluid sealing damper according to Embodiment 2 of the present invention while it is in use.

FIG. 3 is a vertical cross-sectional view showing the viscous fluid sealing damper according to Embodiment 3 of the present invention while it is in use.

FIG. 4 is a vertical cross-sectional view showing a prior art viscous fluid sealing damper while it is in use.

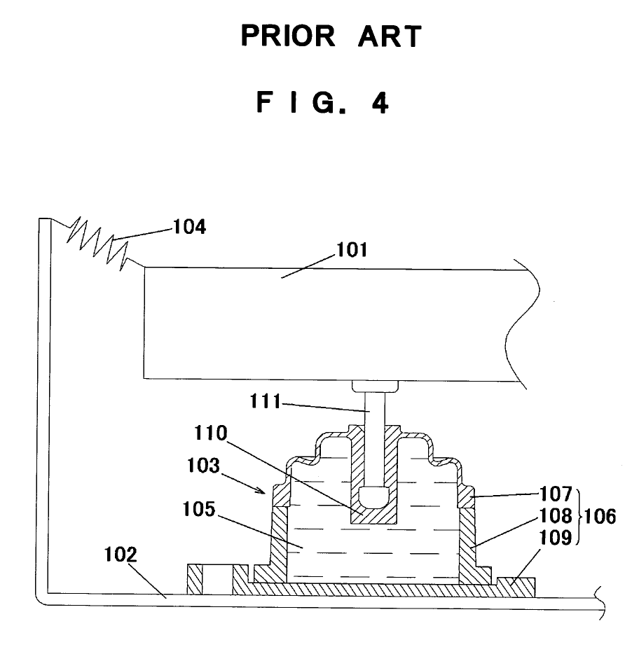

### DESCRIPTION OF THE PREFERRED EMBODIMENTS

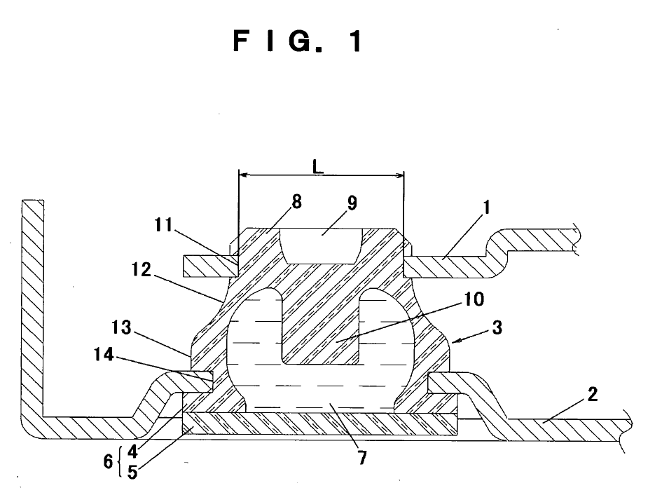

The best embodiment for implementing the viscous fluid sealing damper of the present invention is described hereafter with reference to the drawings. FIG. 1 shows a vertical cross-sectional view of Embodiment 1 of the present invention applied to an in-vehicle disc player with a circular cross-section in any transversal plane.

As shown in FIG. 1, a viscous fluid sealing damper 3 is interposed between a metal plate chassis 1 (the first member) on which an optical pick-up is mounted and a metal plate frame 2 (the second member).

The viscous fluid sealing damper 3 comprises a sealed vessel 6 consisting of a vessel body 4 and a closure 5 and filled with viscous fluid to be sealed, such as silicon oil 7. The vessel body 4 and closure 5 are made of a single material and, in this embodiment, made of a rubber material such as butyl rubber, which is not restrictive. Synthetic resins having a high loss factor equivalent to rubber materials can be used. Furthermore, the viscous fluid to be sealed is not restricted to silicon oil and those having a suitable viscosity are applicable.

A round hole 9 in the form of an open-top recess is formed at the center of the top surface of the one end 8 of the vessel body 4 of the sealed vessel 6. Inside the vessel body 4 of the sealed contained 6, a stirrer 10 having a cylindrical cross-section for stirring the internally sealed viscous fluid protrudes from one end 8 toward the closure 5 that constitutes the other end of the sealed vessel 6. The stirrer 10 is not particularly restricted to a cylindrical form and can have a rectangular or other cross-section.

An annular groove is formed on the outer periphery of one end of the vessel body 4 of the sealed vessel 6 at a position where it surrounds the bottom of the hole 9 to serve as a chassis fitting 11 (the first fitting) for fitting on the chassis 11. The hole 9 allows end 8 to be elastically deformed so that the chassis fitting 11 is easily fit onto chassis 1. Chassis fitting 11 has a diameter L that is substantially larger than the outer diameter of stirrer 10.

With the chassis fitting 11 being positioned outside the outer periphery of the stirrer 10, the portion from the chassis fitting 11 to the stirrer 10 has improved rigidity.

The sealed vessel 6 has a thin-wall 12 below the chassis fitting 11 for flexibility. Elastically deformed, the thin-wall 12 absorbs relative vibrations between the stirrer 10 and the barrel 13.

Furthermore, in the sealed vessel 6, the lower part of the thin-wall 12 is integrally continued to the thick barrel 13. An annular groove is formed on the outer periphery of the thick barrel 13 to serve as a frame fitting 14 (the second fitting) for fitting on the frame 2. The frame fitting 14 is nearly at the same level as the tip of the stirrer 10 (namely at the bottom end in FIG. 1), or at a position where it surround the tip of the stirrer 10.

The frame fitting 14 at this position enhances the rigidity of the barrel 13 and increases the flow resistance between the stirrer 10 and the viscous fluid 7 and, accordingly, the stirring efficiency.

As shown in the figure, the annular part of the frame 2 to be fitted in the frame fitting 14 is cut and raised as shown in the figure, substantially spacing the stirrer 10 and the closure 5 without the closure 5 sticking out below the bottom surface of the frame 2.

The barrel 13 has increased thickness inward at the tip (namely at the bottom in the figure) or toward the internally sealed viscous fluid. The portion from the thin-wall 12 to the tip of the barrel 13 is nearly spherical. With the barrel 13 having increased thickness inward at the tip, the contact area between the vessel body 4 and the closure 5 is increased, thereby increasing their adhesion. Furthermore, barrel 13 having an increased thickness at the tip (at the bottom) serves to increase reinforcement for horizontal vibrations without increasing the outer measurements of the barrel 13.

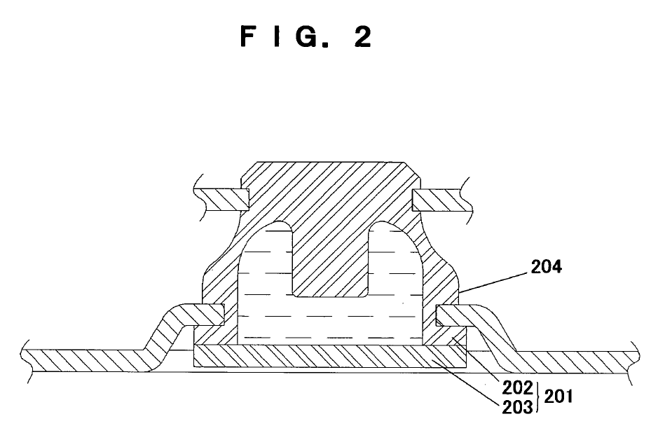

FIG. 2 shows a vertical cross-sectional view of Embodiment 2. The difference in comparison to Embodiment 1 is that a vessel body 202 and a closure 203 together constituting a sealed vessel 201 are made of a synthetic resin having a high loss factor and the vessel body 202 has a barrel 204 having a nearly cylindrical cross-section.

A vessel body like the rubber viscous fluid sealing damper shown in FIG. 1 cannot be produced as a synthetic resin molded item because there is no way to release it from the die. Barrel 204 having a nearly cylindrical cross-section allows molding of the synthetic resin.

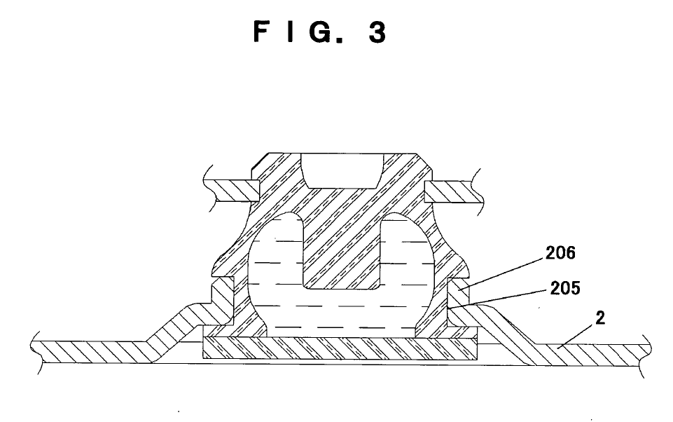

FIG. 3 shows a vertical cross-sectional view of Embodiment 3. The difference in comparison to Embodiment 1 is that the annular groove on the outer periphery of the barrel 204 of the vessel body 202 as the frame fitting 205 (the second fitting) is larger in width and the frame 2 to be fitted in the frame fitting 205 is provided with a cylindrical or annular fit-in part 206.

In Embodiment 3, the barrel 204 of the vessel body 202 is held by frame 2 in a larger area, further reinforcing the part of the barrel 204 that should be reinforced most, allowing the barrel 204 to have a smaller thickness, and further down-sizing the viscous fluid sealing damper.

The present invention was described above with reference to the different embodiments. The present invention is not restricted thereto and includes various further modifications.

What is claimed is:

1. A viscous fluid sealing damper (3) interposed between a first member (1) and a second member (2) for attenuating vibrations propagated between said first and second members, comprising:
a sealed vessel (6) filled with viscous fluid (7), made of a single material, and having one end (8), other end (5), and a barrel (13);
a stirrer (10) protruding inside said sealed vessel from said one end (8) toward said other end (5);
a thin-wall (12) provided to said sealed vessel between said one end and said barrel;
a first fitting (11) provided at said one end of the sealed vessel outside the outer periphery of the stirrer; and
a second fitting (14) provided on the outer periphery of said barrel of said sealed vessel in a position where it surrounds the tip and vicinity of said stirrer;
wherein said first fitting is fitted on said first member and said second fitting is fitted on said second member.

2. The viscous fluid sealing damper according to claim 1 wherein said sealed vessel consists of a vessel body ranging from said barrel to said one end and a closure constituting said other end.

3. The viscous fluid sealing damper according to claim 2 wherein said vessel body and closure are integrated by bonding.

4. The viscous fluid sealing damper according to claim 3 wherein said vessel body and closure are made of rubber.

5. The viscous fluid sealing damper according to claim 4 wherein said barrel of said vessel body has increased thickness inward at the tip.

6. The viscous fluid sealing damper according to claim 1 wherein said first and second fittings are annular grooves.
